(19) United States
(12) Patent Application Publication
(10) Pub. No.: US 2005/0263447 A1
(43) Pub. Date: Dec. 1, 2005

(54) Wastewater treatment system

(76) Inventor: Henry E. McGrew JR., Bossier City, LA (US)

Correspondence Address: John M. Harrison, 2139 E. Bert Kouns, Shreveport, LA, 71105, US

(21) Appl. No.: 11/137,208

(22) Filed: May 25, 2005

Related U.S. Application Data
(60) Provisional application No. 60/574,548, filed on May 27, 2004.

(51) Int. Cl. C02F 1/32; C02F 9/04; B01D 36/00

(52) U.S. Cl. 210/205; 210/206; 210/163; 210/748

(57) ABSTRACT

A wastewater treatment system characterized by a typically underground filter for filtering inlet wastewater and dispensing the filtered wastewater directly into the ground or into a typically underground treatment system of selected configuration, where ultraviolet lamps and/or chlorine or other disinfectant treatment are provided. In a preferred embodiment the filter includes a filter mount or receptacle fitted with a basket-type filter for filtering wastewater entering the filter receptacle at the top and flowing through the basket filter and from the filter mount at or near the bottom. The filtered effluent is discharged into the ground or routed through a treatment piping system that contains either a chlorine solution or other disinfectant and/or one or more ultraviolet lamps, for disinfection. The treated and disinfected effluent is then routed to a holding or treatment tank or collection vessel of choice or to a distribution system.

### CROSS-REFERENCE TO RELATED APPLICATIONS

This application claims the benefit of and incorporates by reference prior filed copending U.S. Provisional Application Ser. No. 60/574,548, Filed May 27, 2004.

### SUMMARY OF THE INVENTION

A wastewater treatment system is characterized by a typically vertically-oriented filter container, mount or receptacle typically extending below grade and provided with a basket-type filter for filtering wastewater effluent and removing entrained solids charged into the filter mount, typically by gravity, and usually at the top of the receptacle. The filtered effluent flows through the filter and from the filter receptacle into the ground or to a treatment system which receives a chlorine solution or other disinfectant and/or ultraviolet lamps mounted in treatment piping and having a selected configuration for disinfecting the effluent. The disinfected effluent is then typically pumped or gravity-fed to a tank or a holding or treatment vessel of choice or to a distribution apparatus such as a sprinkler system.

In a first preferred embodiment of the invention the filtered effluent from the basket filter and filter receptacle flows through an approximately centered outlet pipe that connects to a vertically-oriented treatment vessel designed to receive chlorine tablets or liquid or other liquid or dissolving disinfectant, for disinfecting the filtered effluent flow. The top end of the treatment vessel typically extends above grade, as does the cap or top end of the filter receptacle, to facilitate addition of the disinfectant and insertion and removal of the basket filter, respectively.

In another preferred embodiment of the invention the untreated effluent and entrained solids enter the filter receptacle and flow through the basket filter from the top to the bottom of the filter receptacle, into a discharge line which delivers the filtered effluent to a vertically-oriented treatment pipe, typically fitted with one or more ultraviolet lamps, for disinfecting the effluent. The disinfected effluent then travels through a second discharge pipe to a holding or treatment tank or vessel or to a distribution apparatus or system, as desired. The electrical fittings that attach a power cord to the ultraviolet lamp are insulated from the effluent and the power cord is connected to a source of electric power above grade, according to the knowledge of those skilled in the art.

In still another preferred embodiment of the invention the filtered effluent flows from the filter receptacle at the bottom or the approximate midpoint thereof into the upper end of one leg of a pair of angularly disposed, end-to-end, underground ultraviolet lamp vessels, together typically forming a V-shape and fitted with ultraviolet lamps. The ultraviolet lamp vessels are typically connected at an elbow at the base of the “V” and the opposite ends typically extend above grade. The filtered effluent is treated as it begins its downward travel through the first of the angled ultraviolet lamp vessels and continues to be treated as it moves upwardly in the second slanted or angled ultraviolet lamp vessel, where it is discharged to holding or treating vessel of choice or to a distribution system of suitable design.

In yet another embodiment of the invention the filtered effluent flows from the filter receptacle into a similar angularly-disposed, underground, typically V-shaped pair of ultraviolet lamp vessels, each fitted with at least one internal ultraviolet lamp and connected at the apex of the “V” by a horizontal leg, typically characterized by a tee fitting. The unconnected ends of the ultraviolet lamp vessels typically project above grade level. The effluent flows through the angled ultraviolet lamp vessels for further disinfectant treatment and is then discharged from the second slanted ultraviolet lamp vessel into a holding or treatment tank or other disposition. An upward-standing, typically vertically-oriented clean-out pipe and/or chlorine or other disinfectant treatment pipe having a removable cap extends from the underground tee fitting upwardly to a point above grade for clean-out purposes or to facilitate the addition of disinfectant, as desired.

In still another preferred embodiment under circumstances where the filtered effluent is not treated after filtration, it is discharged, typically by gravity flow, directly into the underlying soil or into a prepared bed for dispersion into the adjacent soil.

### BRIEF DESCRIPTION OF THE DRAWINGS

The invention will be better understood by reference to the accompanying drawings, wherein:

FIG. 1 is a side elevation, partially in section, of a typical filter receptacle and internal basket filter extending below grade for filtering wastewater effluent and removing entrained solids introduced into the top of the filter receptacle and discharged through the center or near the bottom, or both, of the filter receptacle after passing through the basket filter;

FIG. 2 is a side elevation, partially in section, of the filter receptacle and basket filter illustrated in FIG. 1, including connecting treatment piping, all predominantly below grade, wherein the filtered effluent is discharged through the treatment piping for contact with a disinfectant;

FIG. 3 is a side elevation, partially in section, of the filter receptacle and basket filter illustrated in FIGS. 1 and 2, more particularly illustrating an alternative, partially sub-grade configuration of the treatment piping, wherein an ultraviolet lamp is provided in at least one leg of the treatment piping for disinfecting the effluent;

FIG. 4 is a side elevation, partially in section, of the filter mount and basket filter illustrated in FIGS. 1-3, more particularly illustrating another alternative treatment or disinfecting equipment configuration consisting of a V-shaped, partially below-grade piping system having a pair of connected, angled ultraviolet lamp vessels containing ultraviolet lamps for treating the filtered effluent as it flows down the first or left-hand side of the V-shaped leg and up the right-hand V-shaped leg, to an outlet for delivery to a treatment or holding tank or vessel or to other disposition; and

FIG. 5 is a side view, partially in section, of the filter mount and enclosed basket filter illustrated in FIG. 4, more particularly illustrating discharge of the filtered effluent into a similar V-shaped piping system consisting a pair of angled ultraviolet lamp vessels connected at the bottom by a tee fitting and provided with a vertically-oriented clean-out and/or disinfectant-carrying tube that connects to the tee and extends above grade.

### DESCRIPTION OF THE PREFERRED EMBODIMENTS

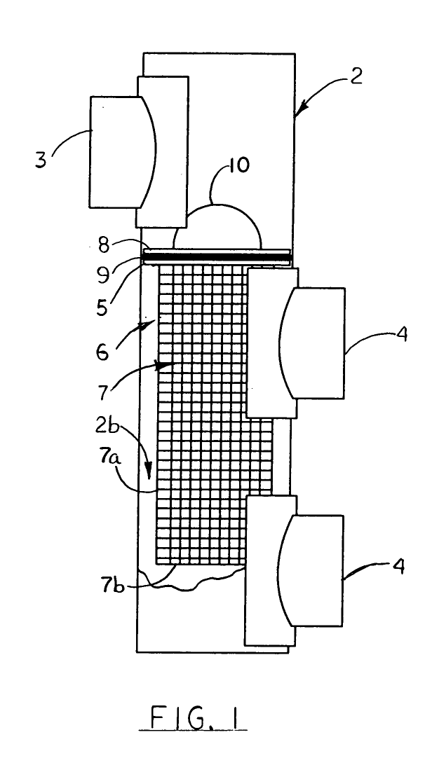

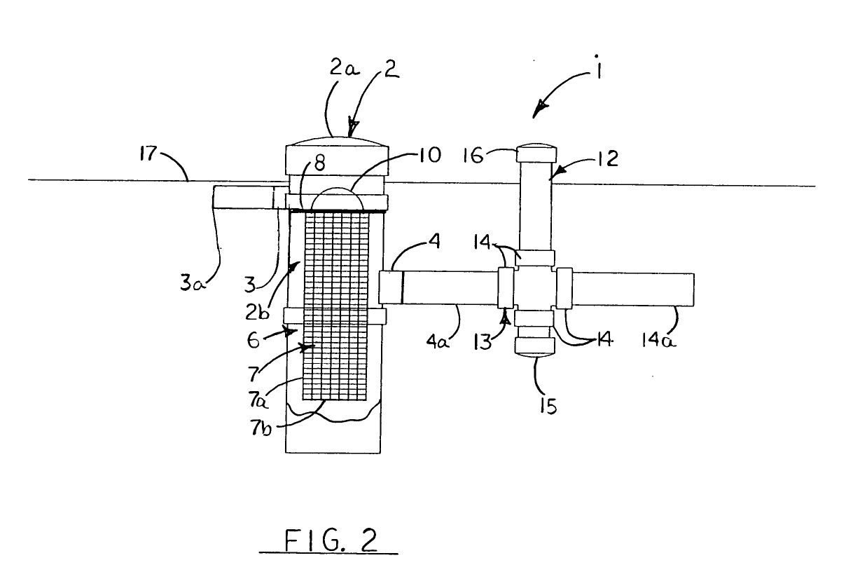

Referring initially to FIGS. 1 and 2 of the drawings, a first wastewater treatment system of this invention is generally illustrated by reference numeral 1. The first wastewater treatment system 1 includes an upward-standing filter receptacle 2 having a removable receptacle cap 2a extending above grade 17, as illustrated in FIG. 2. The filter receptacle 2 includes a filter receptacle inlet fitting 3, typically located below grade and near the top of the filter receptacle 2, and typically, one or a pair of filter receptacle outlets 4, one at the middle and the other typically near the bottom of the filter receptacle 2 (FIG. 1). It will be appreciated that in a preferred embodiment either or both of the filter receptacle outlets 4 can be connected to a filter mount outlet pipe 4a, while the filter receptacle inlet fitting 3 is connected to a filter receptacle inlet pipe 3a, for delivering a stream of effluent and solids wastewater, typically by gravity flow, from a source into the filter chamber 2b of the filter receptacle 2. A basket filter 6 is typically removably seated in the filter chamber 2b by means of a filter flange 8 that removably engages and seats on a supporting filter seat 5, shaped or mounted in the wall of the filter receptacle 2 defining the filter chamber 2b (FIG. 1). An elastomeric flange seal 9 may be provided on the disc-shaped filter flange 8 or on the filter seat 5 to prevent or at least minimize the diversion of the incoming wastewater between the filter flange 8 and the interior wall of the filter receptacle 2.

As further illustrated in FIGS. 1 and 2 of the drawings the basket filter 6 includes a filter screen 7, having a cylindrical screen mesh wall 7a and a screen mesh bottom 7b extending from the filter flange 8 and having a mesh size sufficient to filter the solid material from the incoming wastewater effluent stream. This stream enters the filter chamber 2b from the filter receptacle inlet pipe 3a and the filter receptacle inlet fitting 3 and flows through the basket filter 6 from the open top thereof, and then through the filter screen 7, into the filter receptacle outlet or outlets 4 and into the filter receptacle outlet pipe 4a (FIG. 2). Alternatively, the filter receptacle outlet(s) 4 can be blocked or the filter receptacle 2 may be manufactured with no filter receptacle outlets 4, and the filtered effluent discharged from the open bottom of the filter receptacle 2, if no further effluent treatment is required. In a preferred embodiment the basket filter 6 is fitted with a curved filter bail 10, secured to the filter flange 8, for periodically removing the basket filter 6 from the filter chamber 2b for cleaning purposes after removing the filter receptacle cap 2a from the top end of the filter receptacle 2 projecting above the grade 17 (FIG. 2).

Referring again to FIG. 2 of the drawings the filtered wastewater effluent flowing into the filter receptacle outlet pipe 4a is delivered to a typically vertically-oriented vessel or pipe 12, typically having a 4-way treatment vessel fitting 13 provided with four fitting flanges 14. As in the case of the filter receptacle 2, the top end of the treatment vessel 12 typically projects above the grade 17 and includes a removable top cap 16 for introducing a disinfectant such as chlorine tablets or liquid or the like, into the effluent stream and for clean-out purposes. A bottom cap 15 may also be provided on the 4-way treatment vessel fitting 13 to assist on the clean-out procedure, as deemed necessary. A treatment vessel outlet pipe 14a is extended from another of the filtering flanges 14 for flowing the disinfected wastewater effluent from the treatment vessel 12 to a storage tank or vessel or to an alternative treatment or disposal system (not illustrated).

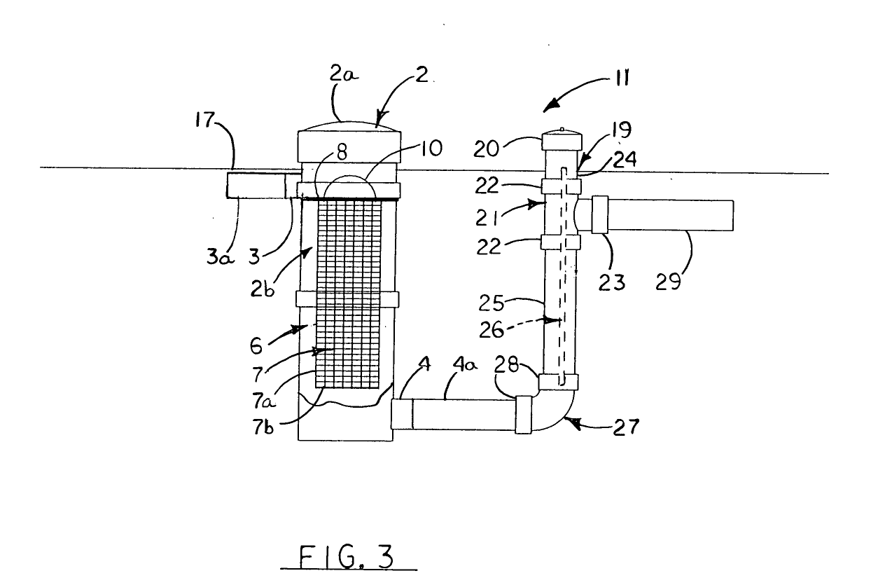

Referring now to FIG. 3 of the drawings in another preferred embodiment of the invention a second wastewater treatment system is illustrated by reference numeral 11 and includes a filter receptacle 2, typically extending below the grade 17 and configured as illustrated in FIGS. 1 and 2 and fitted with an internal basket filter 6. A filter receptacle outlet pipe 4a delivers the filtered wastewater effluent from the bottom of the filter receptacle 2 to the bottom of a typically vertically-oriented ultraviolet (UV) lamp vessel 19, having a top end projecting above the grade 17 and provided with a removable vertical lamp vessel cap 20, for accessing the interior of the vertical UV lamp vessel 19. A tee fitting 21 is typically provided in the vertical UV lamp vessel 19, typically with the run flanges 22 joining an upper vessel pipe 24 (which receives the vertical lamp vessel cap 20), to a lower vessel pipe 25, fitted with an elbow fitting 27, typically with elbow flanges 28 connected to the lower vessel pipe 25 and the filter receptacle outlet pipe 4a, as illustrated. The leg flange 23 of the tee fitting 21 receives a UV lamp vessel outlet pipe 29 that delivers the filtered and disinfected wastewater effluent to a holding tank or vessel or an additional treatment system, or to a disposal system (not illustrated), as deemed necessary. As further illustrated in FIG. 3, one or more ultraviolet (UV) lamps 26 (illustrated in phantom) are mounted inside the vertical UV lamp vessel 19 for disinfecting the stream of filtered wastewater effluent flowing through the vertical UV lamp vessel 19. Suitable waterproof electrical connections and wiring (not illustrated) are provided in and to the UV lamp or lamps 26, according to the knowledge of those skilled in the art, in order to power the UV lamp(s) 26.

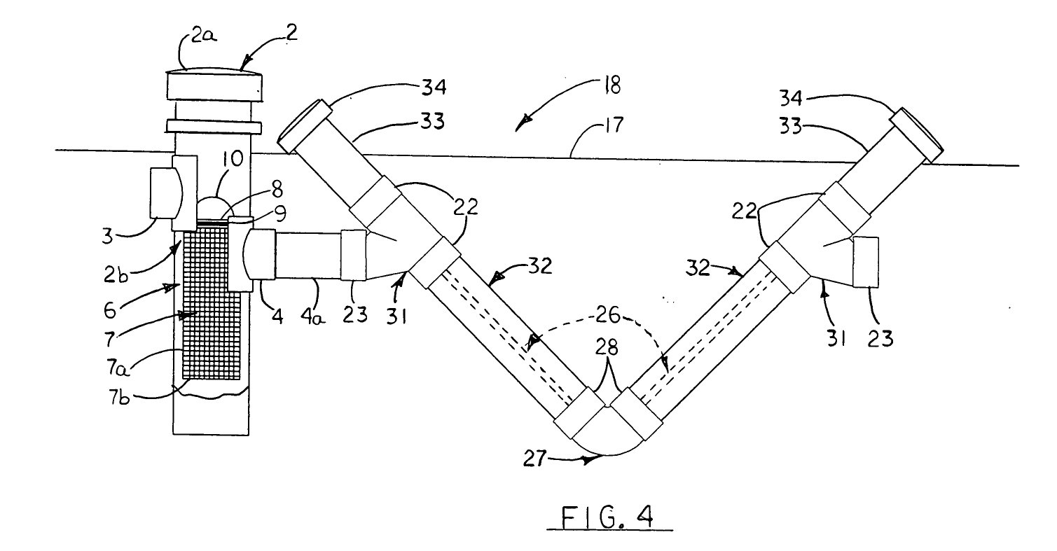

Referring to FIG. 4 of the drawings a third wastewater treatment system 18 is illustrated and typically utilizes a filter receptacle 2 and basket filter 6 combination such as that illustrated in FIGS. 1-3. The filtered effluent is delivered to the upper end of an angled UV lamp vessel 32, typically through an offset tee fitting 31, typically having a leg flange 23 connected to the filter receptacle outlet pipe 4a. The filtered wastewater effluent flows downwardly through the angled UV lamp vessel 32 and is disinfected by operation of one or more UV lamps 26 disposed inside the angled UV lamp vessel 32, as illustrated in phantom. An elbow fitting 27 is typically attached to the bottom end of the angled UV lamp vessel 32 and typically has elbow flanges 28 that connect the angled UV camp vessel 32 to the bottom end of a like angled UV lamp vessel 32 extending upwardly, such that the two connected angled UV lamp vessels 32 define a below-grade “V” configuration. The respective unconnected top ends, or angled vessel extensions 33 of the angled UV lamp vessels 32 typically extend above the grade 17 and are each fitted with an extension cap 34 for accessing the respective interiors of the angled UV lamp vessels 32. The first downwardly-projecting angled UV lamp vessel 32 and the second upwardly-extending angled UV lamp vessel 32 contain the UV lamps 26, and both or all of the UV lamps 26 are fitted with the necessary waterproof electrical fittings and wiring (not illustrated) for illuminating the lamps and disinfecting the flowing stream of filtered wastewater effluent. The disinfected stream of effluent is discharged from near the upper end of the second angled UV lamp vessel 32, typically through a second offset tee fitting 31, into a tank treatment, holding or storage system or to a disposal apparatus or system (not illustrated), as desired.

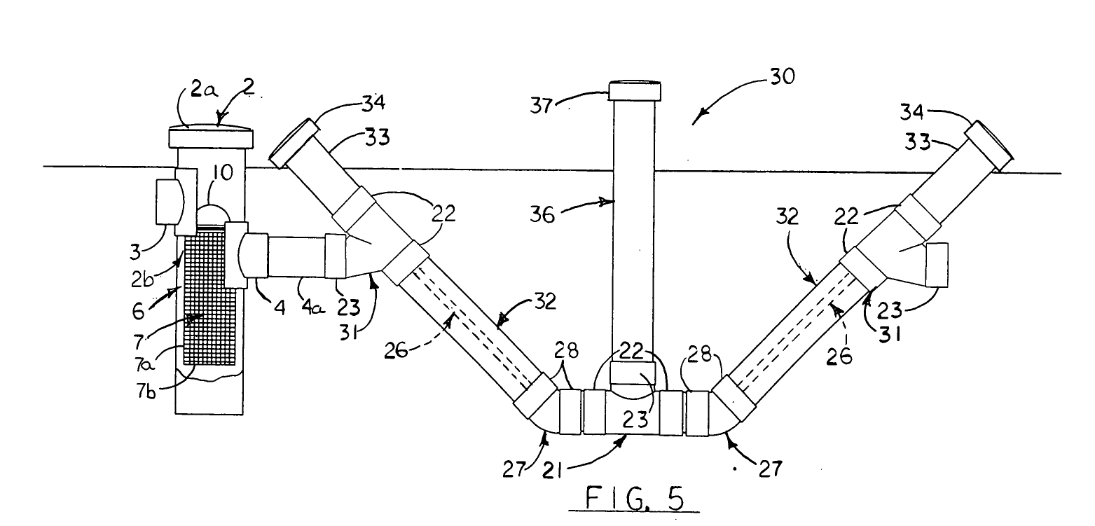

As illustrated in FIG. 5 of the drawings a fourth wastewater treatment system 30 is illustrated and is similar in configuration and operation to the third wastewater treatment system 18 illustrated in FIG. 4. A partially below-grade filter receptacle 2 and basket filter 6 are included for initially filtering the wastewater stream and a filter receptacle outlet pipe 4a delivers the filtered effluent to a disinfecting system characterized by a downwardly-extending angled UV lamp vessel 32, fitted with one or more internal UV lamps 26 and typically terminating at the bottom at a tee fitting 21. An elbow fitting 27, typically having elbow flanges 28, typically joins the angled UV lamp vessel 26 to the run flange 22 of the tee fitting 21. A clean-out pipe 36 is typically vertically-oriented, with the bottom end connected to the leg flange 23 of the tee-fitting 21 below the grade 17 and the top end of the clean-out pipe 36 projecting above the grade level 17 and receiving a removable clean-out pipe cap 37. The bottom end of a second angled UV lamp vessel 32 is connected to the opposite run flange 22 of the tee fitting 21. The second angled UV lamp vessel 32 projects upwardly at an angle and terminates above the grade 17, topped by an angled vessel extension 33 and a removable extension cap 34, in the same manner as the top end of the first angled UV lamp vessel 32. One or more UV lamps 26 are seated inside the second angled UV lamp vessel 32, as further illustrated in phantom in FIG. 5. Accordingly, filtered effluent flows from the filter receptacle 2 through the filter receptacle pipe 4a, into the top area of the first angled UV lamp vessel 32 and downwardly, as it is disinfected by the UV lamp(s) 26. Additional disinfection is effected as the effluent stream flows through the tee fitting 21 and upwardly through the second UV lamp vessel 32 and from this vessel through an offset tee fitting 31. As in the case of the above-described embodiments, the disinfected effluent is directed to a storage tank or vessel for storage, or for further treatment, or to a distribution system, as desired.

It will be appreciated by those skilled in the art that the respective first, second, third and fourth wastewater treatment systems of this invention may be characterized by alternative apparatus. For example, various alternative filter systems other than the filter receptacle 2 and basket filter 6 can be implemented for delivering filtered wastewater effluent to the various disinfectant system illustrated in the drawings and described above. However, in a most preferred embodiment of the invention the filter receptacle 2 and basket filter 6 combination illustrated in FIGS. 1-5 of the drawings and described above in the various filtering and disinfection embodiments is used to separate the solids from the liquid wastewater effluent in this invention.

It will also be understood that the filter receptacle 2 and corresponding basket filter 6 elements, as well as the other disinfection vessels and fittings described herein can be sized and located to accommodate a wastewater treatment stream and treated effluent of substantially any flow rate, determined by gravity or by pumps (not illustrated) of selected size. Moreover, the materials of construction and size of the respective filter screens 7 of the basket filters 6 can be chosen to facilitate filtration of various sized solids, further depending upon the nature and composition of the wastewater stream to be treated.

While the preferred embodiments of the invention have been described above, it will be recognized and understood that various modifications may be made in the invention and the appended claims are intended to cover all such modifications which may fall within the spirit and scope of the invention.

1. A wastewater treatment system comprising a filter receptacle for receiving a stream of wastewater; a filter provided in said filter receptacle for filtering the wastewater flowing through said filter receptacle; and a disinfecting system connected to said filter receptacle for receiving the wastewater from said filter and said filter receptacle and disinfecting the wastewater flowing through said disinfecting system.

2. The wastewater treatment system of claim 1 wherein said disinfecting system comprises at least one treatment vessel connected to said filter receptacle for receiving the wastewater and introducing a disinfectant into the wastewater and disinfecting the wastewater flowing through said treatment vessel.

3. The wastewater treatment system of claim 1 wherein said disinfecting system comprises at least one treatment vessel connected to said filter receptacle for receiving the wastewater and at least one ultraviolet lamp provided in said at least one treatment vessel for disinfecting the wastewater flowing through said at least one treatment vessel.

4. The wastewater treatment system of claim 3 wherein said filter receptacle extends below grade and said at least one treatment vessel comprises a single treatment vessel extending below grade and said at least one ultraviolet lamp comprises a single ultraviolet lamp provided in said treatment vessel for disinfecting the wastewater.

5. The wastewater treatment system of claim 3 wherein said filter receptacle extends below grade and said at least one treatment vessel comprises a pair of treatment vessels extending below grade and connected to each other, each of said treatment vessels disposed in angular relationship with respect to the horizontal, with one of said treatment vessels connected to said filter receptacle for receiving the wastewater.

6. The wastewater treatment system of claim 5 wherein each of said pair of treatment vessels has a bottom end and a top end, said bottom end connected together for receiving a flow of the wastewater and said top end extending above grade, respectively.

7. The wastewater treatment system of claim 5 comprising a clean-out vessel having a bottom end connected to said bottom end of said pair of treatment vessels and a top end projecting above grade for accessing and cleaning said pair of treatment vessels from grade.

8. The wastewater treatment system of claim 1 wherein said filter comprises a basket filter removably seated in said filter receptacle for filtering the wastewater.

9. The wastewater treatment system of claim 8 wherein said disinfecting system comprises at least one treatment vessel connected to said filter receptacle for receiving the wastewater and introducing a disinfectant into the wastewater and disinfecting the wastewater flowing through said treatment vessel.

10. The wastewater treatment system of claim 8 wherein said disinfecting system comprises at least one treatment vessel connected to said filter receptacle for receiving the wastewater and at least one ultraviolet lamp provided in said at least one treatment vessel for disinfecting the wastewater flowing through said at least one treatment vessel.

11. The wastewater treatment system of claim 10 wherein said filter receptacle extends below grade and said at least one treatment vessel comprises a single treatment vessel extending below grade and said at least one ultraviolet lamp comprises a single ultraviolet lamp provided in said treatment vessel for disinfecting the wastewater.

12. The wastewater treatment system of claim 10 wherein said filter receptacle extends below grade and said at least one treatment vessel comprises a pair of treatment vessels extending below grade and connected to each other, each of said treatment vessels disposed in angular relationship with respect to the horizontal, with one of said treatment vessels connected to said filter receptacle for receiving the wastewater.

13. The wastewater treatment system of claim 12 wherein each of said pair of treatment vessels has a bottom end and a top end, said bottom end connected together for receiving a flow of the wastewater and said top end extending above grade, respectively.

14. The wastewater treatment system of claim 12 comprising a clean-out vessel having a bottom end connected to said bottom end of said pair of treatment vessels and a top end projecting above grade for accessing and cleaning said pair of treatment vessels from grade.

15. A wastewater treatment system comprising a filter receptacle extending below grade for receiving a stream of wastewater flowing through said filter receptacle; a basket filter removably provided in said filter receptacle for filtering the wastewater; and a disinfecting vessel extending below grade and attached to said filter receptacle for receiving a disinfectant and disinfecting the wastewater flowing through said disinfecting vessel.

16. The wastewater treatment system of claim 15 comprising at least one ultraviolet lamp provided in said disinfecting vessel for disinfecting the wastewater flowing through said disinfecting vessel.

17. A wastewater treatment system comprising a filter receptacle extending below grade for receiving a stream of wastewater; a basket filter removably seated in said filter receptacle for filtering the wastewater flowing through said filter receptacle; a generally V-shaped disinfecting vessel extending below grade and connected to said filter receptacle; and at least one ultraviolet lamp provided in said V-shaped disinfecting vessel for receiving and disinfecting the wastewater flowing through said V-shaped disinfecting vessel.

18. The wastewater treatment system of claim 17 wherein said at least one ultraviolet lamp comprises a pair of ultraviolet lamps provided in said disinfecting vessel for disinfecting the wastewater flowing through said disinfecting vessel.

19. A wastewater treatment system comprising a filter receptacle extending below grade level for receiving a stream of wastewater; a basket filter removably seated in said filter receptacle for filtering the wastewater flowing through said filter receptacle; a generally V-shaped disinfecting vessel connected to said filter receptacle and having opposite ends extending below grade level and a pair of ultraviolet lamps provided in said disinfecting vessel for disinfecting the wastewater flowing through said V-shaped disinfecting vessel.

20. A wastewater treatment system comprising a filter receptacle for receiving a stream of wastewater; a filter provided in said filter receptacle for filtering the wastewater flowing through said filter receptacle; and at least one discharge opening provided in said filter receptacle for discharging the wastewater from said filter into the environment.
